(19) United States
(12) Patent Application Publication
(10) Pub. No.: US 2007/0024972 A1
(43) Pub. Date: Feb. 1, 2007

(54) Polarization-optimized illumination system

(75) Inventors: Birgit Kuerz, Aalen (DE); Markus Schwab, Herzogenaurach (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/488,002

(22) Filed: Jul. 18, 2006

Related U.S. Application Data
(60) Provisional application No. 60/700,026, filed on Jul. 18, 2005.

(51) Int. Cl. G02B 27/28; G02B 5/30

(52) U.S. Cl. 359/487

(57) ABSTRACT

An illumination system for a microlithography projection exposure apparatus for illuminating an illumination field with the aid of light from a primary light source has an optical axis and a mirror arrangement having a first deflecting mirror and at least one second deflecting mirror. The first deflecting mirror is tilted in relation to the optical axis about a first tilt axis and by a first tilt angle, and the second deflecting mirror is tilted in relation to the optical axis about a second tilt axis and by a second tilt angle. The mirror arrangement is set up such that a total change in the degree of polarization ΔDOP effected by the mirror arrangement is smaller than the first change in degree of polarization ΔDOP1 effected by the first deflecting mirror, or than the second change in degree of polarization ΔDOP2 effected by the second deflecting mirror.

This application claims benefit of US Provisional Application No. 60/700,026 filed on Jul. 18, 2005, which is incorporated into this application by reference.

### BACKGROUND OF THE INVENTION

1. Field of the Invention

The invention relates to an illumination system for an optical device, in particular for a projection exposure apparatus for microlithography, and to a projection exposure apparatus equipped with such an illumination system.

2. Description of Related Techniques

The performance of projection exposure apparatuses for the microlithographic production of semiconductor components and other finely structured components is substantially determined by the imaging properties of the projection optics. Moreover, the image quality and the wafer throughput achievable with an apparatus are also determined substantially by properties of the illumination system based upstream of the projection objective. Said system must be capable of preparing the light from a light source with the highest possible efficiency and, in the process, of setting a light distribution, which can be accurately defined with reference to the position and form of illuminated regions, and in the case of which an intensity distribution that is as uniform as possible is present inside illuminated regions. These requirements are to be fulfilled equally for all settable illumination modes, for example in the case of conventional settings with different degrees of coherence, or in the case of ring field, dipole or quadruple illumination, which are the preconditions for imaging the reticle pattern with a high interference contrast.

A requirement of increasing importance for illumination systems consists in that the latter should be capable of providing output light with a state of polarization that can be defined as precisely as possible. For example, it may be desired for the light falling onto the photomask or into the downstream projection objective to be largely or completely linearly polarized and to have a defined alignment of the preferred direction of polarization. With the aid of linearly polarized input light, it is possible, for example, for modern catadioptric projection objectives to operate with polarization beam splitters (beam splitter cube, BSC) with a theoretical efficiency of 100% at the beam splitter. It can also be desired to provide illuminating light that is largely unpolarized or very well circularly polarized in the region of the photomask. It is thereby possible, for example, to avoid differences in resolution (H-V differences, CD variations) that are dependent on structural direction and which can occur when illumination is performed with linearly polarized light and the typical structural widths of the patterns to be imaged are of the order of magnitude of the wavelength used.

In projection microlithography, the patterns to be imaged are imaged onto the substrate to be exposed on a reducing scale with the aid of a projection objective. Given high image-side numerical apertures of the projection objectives, for example with values of NA=0.85 or more, the vector character of the image producting electric field becomes increasingly clearly apparent. For example, the s-polarized component of the electric field, that is to say that component which oscillates perpendicular to the plane of incidence defined by incidence direction and surface normal to the substrate, interferes more effectively and produces a better contrast than the p-polarized component oscillating perpendicular thereto. By contrast, p-polarized light generally couples more effectively into the photoresist. The strength of the effects increases with the numerical aperture such that an accurate polarization control is desirable, particularly in the field of immersion lithography in which image-side numerical apertures of NA>1 can be reached.

An important specification of an illumination system is therefore the degree of polarization (DOP) at the location of the object to be illuminated in the case of unpolarized operation of the illumination system. The degree of polarization is defined via the Stokes parameter S₀, S₁, S₂ and S₃ as

$$DOP = \frac{\sqrt{{S}_{1}^{2} + {S}_{2}^{2} + {S}_{3}^{2}}}{{S}_{0}} ,$$

and therefore specifies which fraction of the light exhibits a preferred polarization (preferred polarization direction). This residual polarization should, for example, be kept as small as possible in order to minimize CD variations and HV differences of the imaged structures.

Illumination systems for microlithography projection exposure apparatuses are optical systems of complex design and having a multiplicity of optical elements that assume specific tasks in the preparation of the illuminating radiation. In addition to a multiplicity of lenses, optical elements are frequently also provided for varying the photoconductance (geometrical light conductance value, etendu), and optical arrangements for homogenizing the illuminating radiation. In order still to achieve compact designs despite the overall size occasioned thereby, use is frequently made of plane deflecting mirrors (folding mirrors) in order to fold the beam path inside the illumination system. By way of example, patent application US 2003/0026001 A1 exhibits an illumination system having two deflecting mirrors that are respectively tilted by 45° about parallel tilt axes in relation to the optical axis of the illumination system. One of the deflecting mirrors is designed as a dosimetry mirror having a multiplicity of small, transparent regions in order to couple a small radiation fraction out of the beam path for the purpose of dose measurement.

European patent application EP 0 854 374 A2 exhibits an illumination system for a microlithography projection exposure apparatus that is operated with linearly polarized laser light. A number of deflecting mirrors for folding the beam path are arranged in the beam path such that the linearly polarized laser light is p-polarized with reference to each of the deflecting mirrors. The aim of this is to increase the laser resistance of the illumination system, since it is assumed that the mirrors have a higher destruction threshold for p-polarized light than for s-polarized light. A λ/2 plate for rotating the preferred polarization direction by 90° is provided between two consecutive deflecting mirrors, whose tilt axes are aligned perpendicular to one another, such that p-polarization is present at the two consecutive deflecting mirrors.

Patent U.S. Pat. No.5,253,110 exhibits another illumination system for a microlithography projection exposure apparatus in the case of which a number of deflecting mirrors tilted about tilt axes aligned in a mutually perpendicular fashion are arranged one after another.

### SUMMARY OF THE INVENTION

It is one object of the invention to provide an illumination system that is suitable, in particular, for use in a microlithography projection exposure apparatus, which has at least two deflecting mirrors tilted in relation to the optical axis, and which transmits the light of an assigned light source into an exit plane and in so doing permits a defined setting of the state of polarization of the emerging light.

In accordance with one formulation of the invention, these and other objects are achieved by means of an illumination system for a microlithography projection exposure apparatus for illuminating an illumination field with the aid of light from a primary light source, comprising: an optical axis; and a mirror arrangement having a first deflecting mirror and at least one second deflecting mirror; wherein the first deflecting mirror is tilted in relation to the optical axis about a first tilt axis and by a first tilt angle, and the second deflecting mirror is tilted in relation to the optical axis about a second tilt axis and by a second tilt angle; and wherein the mirror arrangement is set up such that a total change in the degree of polarization ΔDOP effected by the mirror arrangement is smaller than the first change in degree of polarization ΔDOP1 effected by the first deflecting mirror, or than the second change in degree of polarization ΔDOP2 effected by the second deflecting mirror.

Because of the complex design, there is usually a multiplicity of sources of residual polarization within the illumination system. These include the optical layers, whose reflectivities and/or transmissivities for s- and p-polarization are generally of different magnitude. Unpolarized light can be regarded as incoherent superimposition of light with two mutually orthogonal states of polarization, for example s- and p-polarization. Light in one of the states of polarization is normally transmitted more strongly on the whole than in the other state of polarization, owing to different reflectivities Rₛ and Rₚ and/or to difference transmissivities Tₛ and Tₚ for s- and p-polarization respectively. This results in a splitting of polarization or preferred polarization, and thus in an increase in the degree of polarization.

According to research conducted by the inventors, the degree of polarization induced by antireflection layers (AR layers) is frequently in the range of 1%-2%, generally exhibits a largely rotationally symmetrical distribution in the pupil of the polarization system, and is weaker in the middle of the illumination field than at the edge of the field. The highly reflective layers of the deflecting mirrors (HR layers) usually induce degrees of polarization of the order of magnitude of up to 1% (doing so independently of layer design), the field and pupil variations usually being slight. Further sources for the variation of the degree of polarization are, for example, birefringent optical materials within the illumination beam path.

Given an unfavorable relative orientation of deflecting mirrors within the illumination system, it can happen that the preferred polarizations induced by the deflecting mirrors reinforce one another, resulting in a contribution to the change in the degree of polarization that is undesired and can be compensated only with difficulty in some instances.

When use is made of the invention, the deflecting mirrors can be combined to form a polarization-compensating mirror arrangement whose polarization-changing effect on the penetrating radiation can be minimized to a value that is tolerable for the illumination system. It is therefore possible, for example, to achieve that in the event of a radiation of unpolarized or circularly polarized light into the mirror arrangement, the output radiation continues largely to be unpolarized or largely to be circularly polarized. The effects of the deflecting mirrors that vary the degree of polarization can in this case cancel one another out partially or completely. Consequently, the advantages of deflecting mirrors can be used for designing illumination systems without their polarization optical disadvantages intolerably impairing the performance of the illumination system.

In terms of one embodiment, the mirror arrangement has two deflecting mirrors that are tilted about parallel tilt axes in relation to the optical axis of the illumination system. The deflecting mirrors are configured such that a ratio Rₛₚ between the reflectivity Rₛ of a deflecting mirror for s-polarized light and the reflectivity Rₚ of the deflecting mirror for p-polarized light from an incidence angle range including the assigned tilt angle is greater than one for one of the deflecting mirrors, and is less than one for the other deflecting mirror. The tilt angles of the deflecting mirrors are defined here as angles between the optical axis at the deflecting mirror and the surface normal of the plane reflecting surface. The incidence angle is defined as the angle between the incidence direction of light on the deflecting mirror and the surface normal. In the case of light incident in a fashion parallel to the optical axis, the incidence angle therefore corresponds to the tilt angle of the deflecting mirror. In the case of light with s-polarization, the electric field vector oscillates perpendicular to the plane of incidence that is defined by the irradiation direction and the surface normal of the deflecting mirror, while with p-polarized light the electric field vector oscillates parallel to this plane of incidence.

The reflectivities for the mirrors for the different polarization directions are therefore designed in such a way that one of the two deflecting mirrors reflects the s-polarization more strongly in the relevant incidence angle range about the tilt angle than the p-polarization, and that in the case of the other deflecting mirror there is an inverse ratio of the reflectivities. It is thereby possible for a variation in the ratio of the reflected intensities for s- and p-polarization caused by the first deflecting mirror to be at least partially compensated with the aid of the reflection at the second deflecting mirror. It can thereby be achieved, for example, that when use is made of circularly polarized or unpolarized input light the state of polarization of the light after two-fold reflection at the deflecting mirrors is at least again approximately circularly polarized or unpolarized without a substantial preference for one of the polarization directions being set by the double reflection at the reflecting mirrors.

In the case of some embodiments, the first and the second tilt angles lie in the range of 45°±15°, in particular of 45°±10°. These preferred tilt angle ranges have the effect that even the incidence angles of the incident radiation have their center point about 45°±15°, that is to say in the vicinity or at least partially in the range of customary Brewster angles in whose region the differences between the reflectivities for s- and p-polarization are particularly large. The invention is therefore particularly useful here for compensating these differences.

For the deflecting mirror with Rₛₚ>1, any embodiment suitable for the relevant wavelength region can be selected, for example a conventional mirror having a reflecting metal layer and a dielectric coating, arranged thereon, with one or more dielectric layers, which can serve to intensify reflection.

The other deflecting mirror, which is intended to reflect more strongly in the relevant incidence angle range for p-polarization (Rₛₚ<1) has, in accordance with one development, a reflective coating having a metal layer and a dielectric layer arranged on the metal layer.

The use of a metal layer that is reflecting for the light used is very advantageous in order to achieve a strong reflection effect of the deflecting mirror over a large angular range. For applications at wavelengths of 260 nm or below, in particular, it is advantageous when the metal layer consists essentially of aluminum. This material combines relatively high reflectivities with satisfactory resistance to energetic radiation. Other metals, for example magnesium, iridium, tin, beryllium or ruthenium are also possible. It has emerged that when use is made of metal layers it is possible to obtain reflective coatings of simple design that over a large angular range reflect the p-polarization component more strongly than the s-polarization component.

The dielectric layer arranged on the metal layer is preferably a multilayer system with a number of individual layers arranged one above another, layers with high-index dielectric material and layers with, compared thereto, low-index dielectric material alternating (dielectric multilayer stack). Lanthanum fluoride (LaF₃) is preferably used as high-index material at 193 nm, and magnesium fluoride (MgF₂) is used as low-index material.

Suitable materials and layer structures for deflecting mirrors with Rₚ>Rₛ are also specified in the international patent application having publication number WO 2004/025370 A1. The disclosure content of the document is to that extent incorporated by reference in this description.

In another embodiment, in the case of which the deflecting mirrors are tilted in relation to the optical axis about parallel tilt axes, a polarization-rotating device for rotating a preferred polarization direction of penetrating light is arranged between the first deflecting mirror and the second deflecting mirror. The effect of said polarization-rotating device is designed such that polarization-dependent differences in the effect of reflectivity and phase of the deflecting mirrors are compensated at least partially. The polarization-rotating device can be used to operate the deflecting mirrors such that, given high total reflectivity, the overall result is that the mutually vertically oscillating field components of the electric field vector experience a vanishing or only very slight splitting of the amplitude and phase profiles. The polarization-rotating device is to be designed such that a polarization-splitting effect of the first deflecting mirror, caused by dielectric multilayer reflective coatings, for example, is compensated by the corresponding effect of the second deflecting mirror to such an extent that a possibly still present residual splitting of the directions of polarization lies below a harmless threshold after the second reflection.

In the case of conventional, highly reflecting multilayer coatings, it is known that the light fraction of the incident light reflects with a higher reflectivity for which the electric field vector oscillates perpendicular to the plane of incidence (s-polarization). The reflectivity for p-polarized light, for which the electric field vector oscillates parallel to the plane of incidence, is, by contrast, smaller over the entire range of incidence angle and reaches its minimum at the layer-specific Brewster angle. Consequently, large amplitude splits occur, particularly in the region about the Brewster angle. Moreover, phase differences occur between the various polarization directions. If, for example, circularly polarized light falls onto such a conventional, obliquely positioned deflecting mirror, the p-component is more strongly attenuated than the s-component after the reflection. If a rotation of the preferred polarization directions then takes place in the optical path between the first and second deflecting mirrors, for example by approximately 90°, the second deflecting mirror is irradiated with light for which the s-polarized (with reference to the second deflecting mirror) component, which corresponds to the p-polarized component after first reflection, has a smaller amplitude than the p-component. Given conventional coating, the second deflecting mirror will again reflect the p-component more weakly than the s-component, and so it is possible as a result to achieve a far-reaching compensation of the differences of the reflected amplitudes for s- and p-polarizations. A compensation effect also results for the phase differences built up at the first deflecting mirror. The polarization-rotating device is therefore preferably designed for rotating the preferred polarization direction by approximately 90° between the deflecting mirrors.

The specific rotation of the polarization between the first and second deflecting mirrors permits the use for the first and second deflecting mirrors of conventional highly reflecting reflective coatings with Rₛₚ>1 that are constructed and can be produced relatively simply.

The retardation device is preferably mounted at a position at which the divergence of the beams penetrating is minimal, since the effect of conventional retardation elements is strongly dependent on angle. Particularly favorable is an arrangement in the near zone of a pupil of the illumination system.

It is possible for the polarization-rotating device to comprise a λ/2 retardation element, for example a λ/2 plate or an element of corresponding effect. This can be a thin plate made from magnesium fluoride, for example.

It is also possible for the polarization-rotating device to have at least one retardation element that consists of a calcium fluoride crystal or a barium fluoride crystal or another cubic crystal material with intrinsic birefringence, the optical axis of the retardation element being aligned approximately in the direction of a <110> crystallographic axis or a main crystal axis equivalent thereto. The thickness can be dimensioned such that the effect of a λ/2 plate is achieved. It is known from the Internet publication entitled “Preliminary determination of an intrinsic birefringence in CaF₂” by John H. Burnett, Eric L. Shirley and Zachary H. Levine, NIST Gaithersburg, Md. 20899, USA (posted on 7.5.2001) that calcium fluoride single crystals exhibit intrinsic birefringence, that is to say birefringence that is not voltage-induced. The measurements presented show that a birefringence of (6.5±0.4) nm/cm at a wavelength of λ=156.1 nm occurs for beam propagation in a direction of the <110> crystallographic axis or equivalent directions. The value drops toward higher wavelengths and is (3.6±0.2) nm/cm at 193.09 nm, for example. Measurements by the applicant even exhibit values of approximately 11 nm/cm for λ=157 nm. By contrast, the birefringence in the other crystal directions is small. A corresponding residual birefringence with a maximum in the <110> direction of the crystal is also found for barium fluoride single crystals, being approximately 25 nm/cm at 157 nm, and thus being approximately twice as high by comparison with calcium fluoride single crystals.

The intrinsic birefringence of these materials, which is a maximum for passage of the beam parallel to the crystal directions of type <110>, can be used in a targeted fashion as operating mechanism for retardation elements. Because of the relatively low values of the birefringence (by comparison with magnesium fluoride, for example), such retardation elements can be several millimeters or centimeters thick, the result being to facilitate fabrication and, if appropriate, mounting of such elements. Typical thicknesses can be more than approximately 5 mm, in particular between approximately 10 mm and approximately 50 mm. It is also advantageous that because of the relatively low birefringence slight fluctuations in the thickness of the elements have only a slight influence on the retardation effect. The high tolerance with respect to variations in thickness can be used, for example, to form at least one surface of such a retardation element as a functional surface. For example, it is possible for at least one of the end faces to be curved spherically or aspherically or as a free-form surface, such that the retardation element can also contribute to the correction of the illumination system.

Another possibility for providing a retardation element with the effect of a λ/2 plate consists in using a transparent material with stress birefringence (SDB), and in stressing said material with the aid of externally acting mechanical forces such that the element has the λ/2 retardation effect. Use may be made for this purpose of, for example, plates made from amorphous quartz glass or from calcium fluoride.

Finally, it is also possible to achieve the desired retardation effect by using a plate or a similar optical element made from an optically active material that effects a 9020 rotation of the polarization direction upon being transirradiated. Such a plate can consist, for example, of crystalline quartz of suitable thickness.

Apart from following from the claims, the present and further features also follow from the description and the drawings, the individual features being implemented respectively on their own or conjointly in the form of subcombinations in embodiments of the invention or in other areas, and can constitute designs that are advantageous and capable of protection per se.

### BRIEF DESCRIPTION OF THE DRAWINGS

FIG. 1 shows a schematic side view of a microlithography projection exposure apparatus having an embodiment of an illumination system according to the invention;

FIG. 2 shows a schematic of the reflectivities of a reflective layer for p- and s-polarized light as a function of incidence angle;

FIG. 3 shows a schematic side view of a microlithography projection exposure apparatus having another embodiment of an illumination system according to the invention; and

FIG. 4 shows a diagram of the reflectivities of an embodiment of a reflective layer as a function of incidence angle, for a 45° deflecting mirror in the case of which it holds that Rₚ>Rₛ in the incidence angle range used.

### DETAILED DESCRIPTION OF THE PREFERRED EMBODIMENTS

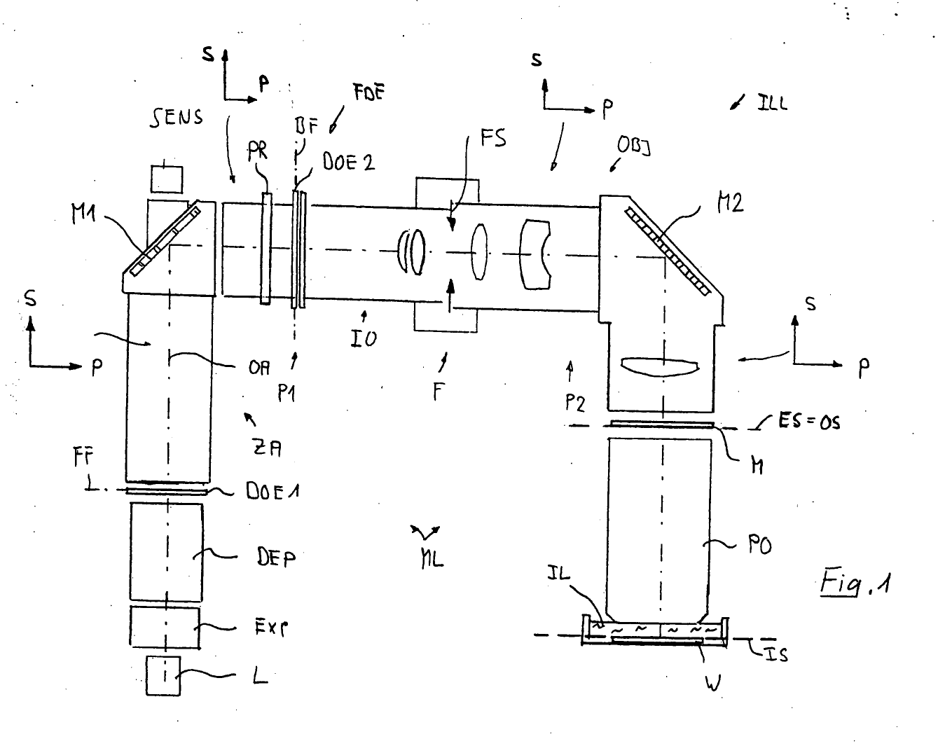

FIG. 1 shows an embodiment of a microlithography projection exposure apparatus ML designed for immersion lithography and that can be used to produce semiconductor components and other finely structured components, and that operates with light from the deep ultraviolet (DUV) region in order to achieve resolutions of down to fractions of micrometers. Serving as light source L is an ArF excimer laser with an operating wavelength λ of approximately 193 nm, whose light beam is aligned coaxially with the optical axis OA of the illumination system ILL. Other UV light sources, for example F₂ lasers with an operating wavelength of 157 nm, KrF excimer lasers with an operating wavelength of 248 nm, or mercury-vapor lamps with operating wavelengths of 368 nm or 436 nm, or light sources with wavelengths of below 157 nm are likewise possible.

The linearly polarized light of the light source L firstly enters a beam expander EXP that serves to reduce coherence and enlarge the beam cross section. The expanded laser beam passes through a depolarizer DEP that produces unpolarized exit light from linearly polarized entrance light. A wedge polarizer of the type shown in U.S. Pat. No. 6,535,273 B1, for example, can be used as depolarizer. The disclosure of this document is incorporated in this description by reference. A first diffractive optical raster element DOE1 serving as beam-shaping element is arranged in the front focal plane BF of an objective ZA that is arranged downstream in the beam path and is designed as a variably settable part of a pupil-shaping unit that generates a prescribeable two-dimensional illumination intensity distribution in the rear focal plane BF of the objective ZA. The variable objective ZA is designed as a focal length zoom objective with integrated conical axicon surfaces of adjustable spacing, the rear focal plane BF being a Fourier-transformed plane relative to the front focal plane FF. Situated in the region of the rear focal plane is a first pupil surface P1 of the illumination system. Seated there is a refractive, second optical raster element DOE2 that likewise serves as beam-shaping element. The second optical raster element is a constituent of a field-defining optical element FDE that simultaneously functions as homogenizing device and effects a homogenization of the illumination intensity distribution in the illumination field. The field-defining optical element FDE can be designed in the manner of a honeycomb condenser, or include such. The mode of operation of a honeycomb condenser is described, for example, in WO 2005/026822 A of the applicant.

A coupling optical system 10 arranged downstream thereof transmits the light onto an intermediate field plane F in which a reticle/masking system (REMA) FS is arranged that serves as an adjustable field stop for sharply delimiting the edges of the illumination field.

An imaging objective OBJ downstream of the intermediate field plane F images the intermediate field plane with the masking system FS into the exit surface ES of the illumination system, where an illumination field of prescribed shape and size is present with a largely homogeneous illumination intensity and a prescribeable angular distribution of the illuminating radiation. This illumination field is used to illuminate a mask M (reticle, lithography original) bearing a pattern. In the exemplary case, the magnification ratio of the objective OBJ is approximately 1:1, while in other embodiments magnification ratios of between approximately 2:1 and 1:5 are provided. A second pupil surface P2 of the illumination system is situated between the object plane of the objective OBJ (intermediate field plane F) and its image plane, which coincides with the exit plane ES of the illumination system.

Following downstream of the exit plane ES of the illumination system, which coincides with the object surface OS of a downstream projection objective PO, is the projection objective PO, which acts as a reduction objective and projects a reduced image of a pattern, arranged on the mask, on a reduced scale, for example on the scale 1:4 or 1:5, onto a wafer W that is coated by a photoresist layer and is arranged in the image surface IS of the projection objective. Refractive or catadioptric projection objectives are possible. Other reduction scales, for example stronger demagnifications down to 1:20 or 1:200, for example, are possible. The refractive projection objective PO in FIG. 1 is designed as an immersion objective and has an image-side numerical aperture NA>1 in conjunction with an immersion liquid IL (here: water) arranged between the exit surface of the projection objective and the surface of the wafer that is to be exposed.

Arranged inside the adjustable objective ZA is a plane first deflecting mirror M1 whose reflecting plane is tilted by 45° to the optical axis OA about a first tilt axis aligned perpendicular to the plane of the drawing, this tilting being such that the optical axis is folded by 90° at the deflecting mirror M1. The first deflecting mirror M1 is designed as a geometric beam splitter and has a multiplicity of transparent holes through which a small fraction of the incident radiation can enter a photosensitive energy sensor SENS of an integrated radiation measurement system of the illumination system. A partially transparent mirror suitable for this purpose and having statistically distributed holes, and a method of producing it are disclosed, inter alia, in patent application US 2003/0026001 A1 whose disclosure is incorporated in this description by reference.

A plane second deflecting mirror M2 that is likewise tilted by 45° relative to the optical axis OA and consequently effects a 90° folding of the optical axis, is arranged inside the imaging objective OBJ, which follows the intermediate field plane F, in the vicinity of the pupil surface P2 of said objective. The tilt axes (running perpendicular to the plane of the drawing) of the two deflecting mirrors M1, M2 run in parallel. The illumination system, which is very long along the optical axis, is folded at two sites and can therefore be designed with dimensions that are compact overall. In addition, the doubled-folded design permits the moveable elements of the adjustable objective ZA to be guided vertically, and the exit radiation to be directed onto a horizontally aligned mask.

A polarization-rotating device PR in the form of a λ/2 plate is arranged between the deflecting mirrors M1 and M2 in the exit-side region of the adjustable objective ZA in the vicinity of the first pupil surface P1 of the illumination system. This retardation element can consist of birefringence crystal material such as magnesium fluoride, for example. Because of the strong birefringence, retardation plates of the lowest order are rendered very thin, and this can give rise to difficulties in production engineering and mounting technology. Plates of higher retardation order and correspondingly greater thickness are certainly possible, but exhibit far less angular tolerance, and so the retardation effect varies strongly for different angles of incidence. More favorable, by contrast, are plates made from calcium fluoride or another crystalline material that exhibits stress birefringence owing to the external forces or to the production process (compare, for example, U.S. Pat. No. 6,191,880 or U.S. Pat. No. 6,201,634).

This retardation element effects a rotation of preferred polarization directions of the light by 90° in the optical path between the first and the second deflecting mirrors. In the embodiment shown, the polarization-rotating device PR is arranged in the immediate vicinity of the first pupil surface P1 of the illumination system, where only a slight angular bandwidth of the radiation penetrating exists. As a result of this, the desired λ/2 retardation is achieved over the entire beam cross section with only a narrow fluctuation range.

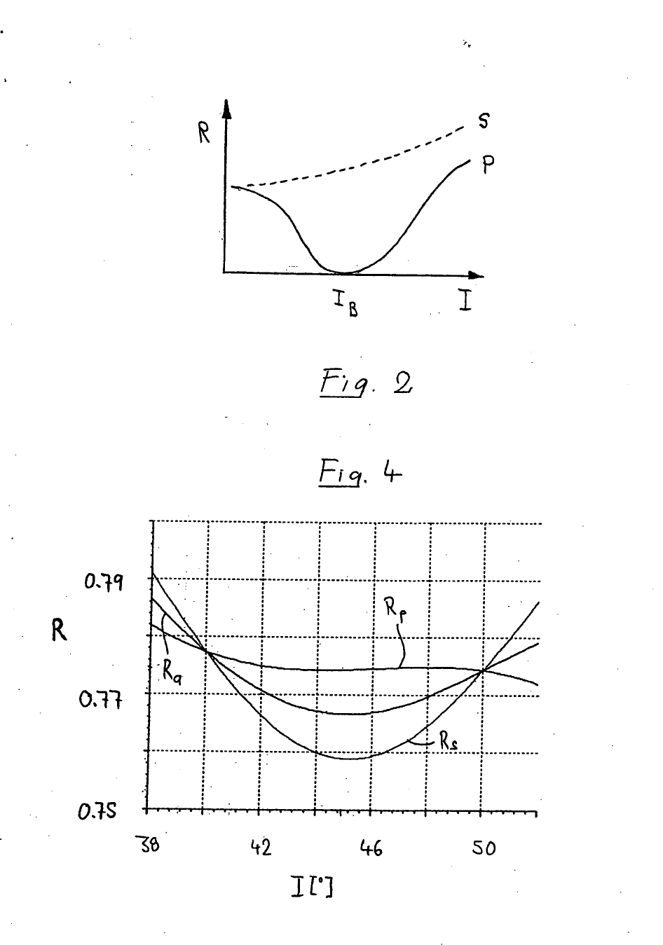

The plane reflecting surfaces of the deflecting mirrors M1 and M2 are coated with highly reflective layers (HR layers) in order to achieve high reflectivities. Said layers preferably comprise one or more layers made from dielectric material whose refractive indices and layer thicknesses are selected so as to amplify reflection in the incidence angle range used. These layers introduce a phase difference, dependent on polarization, between the field components, aligned perpendicular to one another, of the electric field vector of the reflected light (s-polarization and p-polarization, respectively). This arises because the layers for s- and p-polarization constitute different optical paths as a function of the incidence angle of the rays, depending on the incidence angle. Moreover, conventional multiple layers have different reflectivities for s- and p-polarization. A profile of the reflectivity R as a function of the incidence angle I that is typical for multiple layers is shown schematically in FIG. 2. In the event of perpendicular light incidence (incidence angle I=0°), the reflectivities for s- and p-polarization are equal. With a rising incidence angle, the reflectivity for s-polarization increases monotonically, while the reflectivity for p-polarization firstly decreases down to the Brewster angle I_{B} and then increases as the incidence angle rises further. Thus, in general with conventional reflective layers the reflectivity for s-polarization over the entire incidence angle range is greater than for p-polarization, particularly strong differences in reflectivity that lead to so-called polarization splitting resulting in the range of the Brewster angle lying at approximately 54° to 60°, as a rule.

In the event of the use of conventional highly reflecting reflective layers on the two deflecting mirrors M1 and M2, this polarization splitting associated with the use of unpolarized or circularly polarized entrance light downstream of the depolarizer will have the effect that a first change in degree of polarization ΔDOP1 that corresponds to a severe attenuation of the p-component would be introduced in a first step by the reflection at the first deflecting mirror M1. The second change in degree of polarization 66 DOP2 effected by the reflection at the second deflecting mirror M2 would likewise correspond to an attenuation of the p-component that is more severe by comparison with the s-polarization and would be added to the previously occurring attenuation such that the polarization-splitting effects of the deflecting mirrors M1 and M2 would be mutually amplified. The exit radiation of the illumination system would therefore have in its exit plane ES a preferred polarization direction that would be marked by a stronger amplitude or intensity of the s-component. Differences in resolution dependent on structural directions at the exit of the projection objective PO could thereby be amplified.

These problems are avoided in the case of the embodiment shown in FIG. 1 because the polarization of the light is rotated by 90° with the aid of the polarization-rotating device PR between the deflecting mirrors M1 and M2. The effect is explained with the aid of the arrow diagrams that are depicted in FIG. 1 and in the case of which the lengths of the mutually perpendicular arrows show the relative amplitudes of the s- and p-components of the electric field vector at the respective location in the beam path. As already mentioned, unpolarized light is present immediately upstream of the first deflecting mirror M1, and so the amplitudes of s-component and p-component are equal (equal arrow length). The p-component is more severely attenuated relative to the s-component by the reflection at the first deflecting mirror, and so preferred polarization in the s-direction is present downstream of the first deflecting mirror and upstream of the polarization-rotating device PR (greater arrow length of the s-polarization). The passage of the radiation through the λ/2 plate introduces a phase retardation by λ/2 that corresponds to a rotation of the preferred polarization directions by 90°. The result of this is that the light that is s-polarized with reference to the second deflecting mirror M1 has the (weaker) amplitude of the p-polarized fraction downstream of the first deflecting mirror, while the p-component now has the greater amplitude. These amplitude relationships are present directly before reflection at the second deflecting mirror M2. In the case of this radiation, the p-component is now more severely attenuated, because of the differences in reflectivity explained with the aid of FIG. 2, than the (weaker) s-component, and so an adaptation of the amplitudes for s- and p-polarization results. The total change in degree of polarization ΔDOP effected by the polarization-compensated mirror arrangement is therefore smaller than ΔDOP1 or ΔDOP2. The multiple layers of the deflecting mirrors M1 and M2 are preferably designed in this case such that substantially equal amplitudes for s- and p-polarization are present downstream of the second deflecting mirror M2, something which corresponds to the relationships in the case of unpolarized radiation or circularly polarized radiation. The mask can be illuminated with the aid of this light.

A polarization rotation between deflecting mirrors from the range of projection objectives for microlithography is disclosed, for example, in US application of file reference 11/019,202 (published as WO 2004/001480 A2). The disclosure of this document is incorporated in this description by reference.

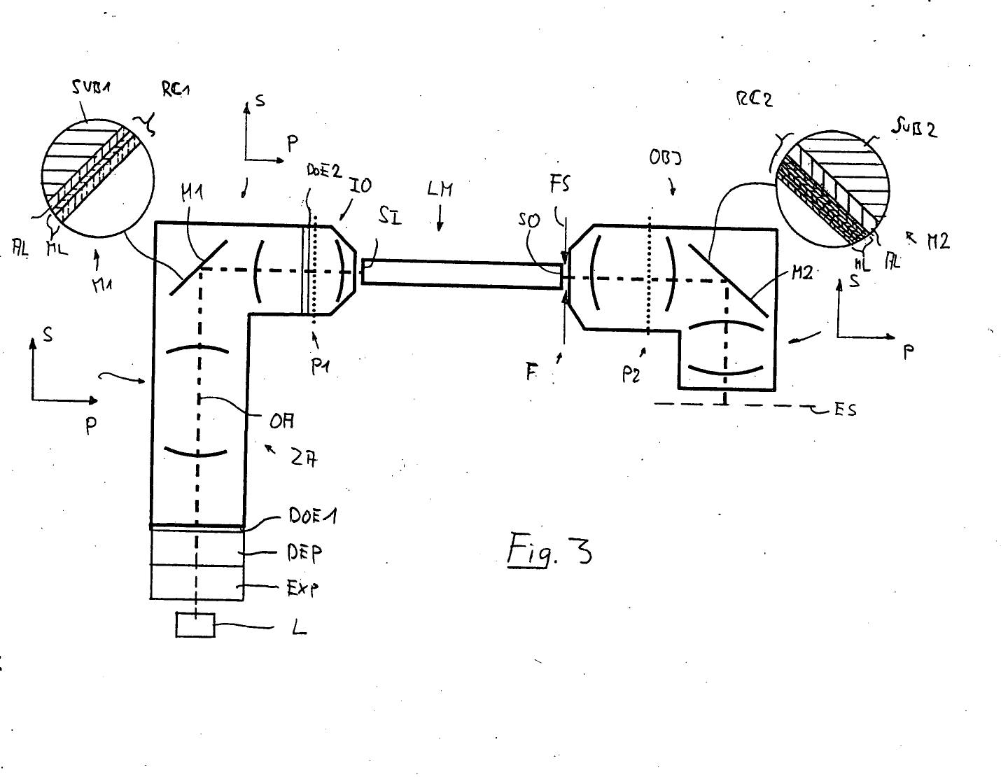

FIG. 3 is a schematic of another embodiment of an illumination system ILL. Identical or corresponding features are designated with the same identifications as in FIG. 1. Reference is made to the corresponding description.

An important difference from the embodiment of FIG. 1 resides in the concept of providing a uniform (homogeneous) illumination intensity in the illumination field. Whereas in the case of the embodiment in FIG. 1 the field-defining optical element FDE contributes to homogenization, in the case of the embodiment in accordance with FIG. 3 there is provided between the exit surface of the coupling optical system 10 and the intermediate field plane F with the reticle/masking system FS as light mixing device LM a rod-shaped light integrator of rectangular cross section. The entrance surface SI of the rod integrator lies in a field plane of the illumination system that is equivalent to the intermediate field plane F. The exit surface SO lies in the immediate vicinity of the intermediate field plane F with the reticle/masking system. The light is mixed and homogenized inside the light mixing device by multiple internal reflection and emerges in a largely homogenized fashion at the exit SO of the light mixing device.

Another important difference consists in the design and function of the polarization-compensated mirror arrangement that comprises the two deflecting mirrors M1 and M2 tilted about parallel tilt axes, and that requires no polarization-rotating device.

As in the case of the embodiment in accordance with FIG. 1, the reflecting surfaces of the first deflecting mirror M1 and the second deflecting mirror M2 are coated with highly reflecting reflective coatings RC1 and RC2 for the purpose of achieving high reflectivities. The reflective layer RC1 of the first deflecting mirror can be of conventional design. In the example, there is applied to the mirror substrate SUB1 an aluminum layer AL to which there is applied for the purpose of amplifying the reflection a dielectric multilayer system ML having a number of individual layers made from transparent dielectric materials of different refractive index. Layers of this type are known per se, for example from U.S. Pat. No. 4,856,019, U.S. Pat. No. 4,714,308 or from U.S. Pat. No. 5,850,309. Also possible are reflective coatings having a metal layer, for example an aluminum layer, and a single dielectric protective layer, for example made from magnesium fluoride, applied thereto. Such layer systems are likewise represented in the cited documents. In the relevant incidence angle range, such conventional layer systems reflect s-polarization around 45° substantially more strongly than p-polarization (compare FIG. 2). The more severe attenuation of the p-component effected thereby in the case of the reflection at the first deflecting mirror is compensated as far as possible by the reflective coating RC2 of the second deflecting mirror. To this end, the reflective layer RC2 is designed such that in the relevant incidence angle range around approximately 45° it has a substantially higher reflectivity for p-polarized light than for s-polarization, and so it holds that Rₛₚ<1 for a ratio Rₛₚ between the reflectivity Rₛ for s-polarized light and the reflectivity Rₚ for p-polarized light. In particular, it holds that Rₛₚ <0.9.

In order to achieve this, an optically thick aluminum layer AL that is coated with a dielectric multilayer system ML is applied to the mirror substrate SUB2. The specification of the reflective layer RC2 is specified in table 1.

TABLE 1

| Thickness [nm] | Material |
|---|---|
| 999.0 | Al |
| 24.9 | LaF₃ |
| 46.1 | MgF₂ |
| 39.2 | LaF₃ |
| 42.8 | MgF₂ |
| 34.0 | LaF₃ |
| 35.3 | MgF₂ |
| 14.4 | LaF₃ |
| 13.4 | MgF₂ |
| 25.3 | LaF₃ |
| 25.1 | MgF₂ |

The multilayer system (multilayer stack) applied to an aluminum layer with a layer thickness of approximately 1 μm has 10 individual layers of alternately high-index and low-index material, the first layer bordering directly on the aluminum layer consisting of high-index lanthanum fluoride (LaF₃), and the last layer bordering on the ambient medium consisting of low-index magnesium fluoride (MgF₂). Table 2 shows the real part Re(n) and the imaginary part lm(n) of the refractive index n at 193 nm for the layer materials used.

TABLE 2

| | Re(n) | Im(n) |
|---|---|---|
| Al | 0.2489 | 2.04 |
| MgF2 | 1.402 | 0.0002 |
| LaF3 | 1.654 | 0.0002 |

FIG. 4 shows for this reflective layer the dependence of the reflectivities Rₚ for p-polarized light and Rₛ for s-polarized light (as well as the mean value Rₐ of the reflectivity) in the incidence angle range of interest here around the tilt angle (45°) of the deflecting mirror. It holds for an incidence angle of 45° that Rₛ=0.758 and Rₚ=0.775, and so the condition Rₛₚ=Rₛ/Rₚ<1 is fulfilled.

Other possibilities for designing deflecting mirrors with Rₚ>Rₛ are specified in the international patent application published under number WO 2004/025370 A1.

This deflecting mirror can be used to compensate partially or entirely the preference for the s-polarization that is caused by the first deflecting mirror, by virtue of the fact that the s-component is substantially more weakly reflected in the case of the second deflecting mirror M2 than is the p-component. This leads in the optical path downstream of the second deflecting mirror to the fact that the amplitudes (or intensities) of the s-component and the p-component are substantially equal (see arrow diagram). Consequently, a reticle located in the exit plane ES of the illumination system can be illuminated with the aid of substantially unpolarized or with the aid of circularly polarized light. The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1. An illumination system for a microlithography projection exposure apparatus for illuminating an illumination field with light from a primary light source, comprising:
an optical axis; and
a mirror arrangement having a first deflecting mirror and at least one second deflecting mirror;
wherein the first deflecting mirror is tilted in relation to the optical axis about a first tilt axis and by a first tilt angle, and the second deflecting mirror is tilted in relation to the optical axis about a second tilt axis and by a second tilt angle; and
wherein the mirror arrangement is such that a total change in the degree of polarization ΔDOP effected by the mirror arrangement is smaller than a first change in degree of polarization ΔDOP1 effected by the first deflecting mirror, and is smaller than the second change in degree of polarization ΔDOP2 effected by the second deflecting mirror.

2. The illumination system as claimed in claim 1, wherein the mirror arrangement has the two deflecting mirrors that are tilted about parallel tilt axes in relation to the optical axis of the illumination system, and wherein the deflecting mirrors are configured such that a ratio Rₛₚ between the reflectivity Rₛ of a deflecting mirror for s-polarized light and the reflectivity Rₚ of the deflecting mirror for p-polarized light from an incidence angle range including the assigned tilt angle is greater than one for one of the deflecting mirrors, and is less than one for the other of the deflecting mirrors.

3. The illumination system as claimed in claim 1, wherein for one of the deflecting mirrors the ratio Rₛₚ is smaller than 0.9 in the case of an incidence angle corresponding to the assigned tilt angle.

4. The illumination system as claimed in claim 1, wherein the first and the second tilt angles lie in a range of 45°±15°.

5. The illumination system as claimed in claim 1, wherein one of the deflecting mirrors comprises a reflective coating having a metal layer and a dielectric layer arranged on the metal layer, the design of the dielectric layer being such that the ratio Rₛₚ is smaller than one in an incidence angle range comprising the assigned tilt angle of the deflecting mirror.

6. The illumination system as claimed in claim 5, wherein the metal layer consists at least essentially of aluminum.

7. The illumination system as claimed in claim 5, wherein the dielectric layer arranged on the metal layer is a multilayer system with a plurality of individual layers arranged one above another, layers with high-index dielectric material alternating with layers of comparatively low-index dielectric material.

8. The illumination system as claimed in claim 7, wherein lanthanum fluoride (LaF₃) is the high-index dielectric material, and magnesium fluoride (MgF₂) is the low-index dielectric material.

9. The illumination system as claimed in claim 1, wherein a polarization-rotating device for rotating a preferred polarization direction of penetrating light is arranged between the first deflecting mirror and the second deflecting mirror for the purpose of compensating polarization-dependent differences in at least one of reflectivity and phase of the deflecting mirrors.

10. The illumination system as claimed in claim 9, wherein the polarization-rotating device is designed for rotating the preferred polarization direction by approximately 90° between the deflecting mirrors.

11. The illumination system as claimed in claim 9, wherein the polarization-rotating device is arranged in a near zone of a pupil surface of the illumination system.

12. The illumination system as claimed in claim 9, wherein the polarization-rotating device is a retardation device that has at least approximately the effect of a λ/2 plate, and that is arranged between the first deflecting mirror and the second deflecting mirror.

13. The illumination system as claimed in claim 9, wherein the polarization-rotating device is a λ/2 plate.

14. The illumination system as claimed in claim 9, wherein the polarization-rotating device has at least one retardation element that consists of a cubic crystal material with intrinsic birefringence, an optical axis of the retardation element being aligned approximately in the direction of a <110> crystallographic axis of the cubic crystal material.

15. The illumination system as claimed in claim 14, wherein the retardation element consists of a calcium fluoride crystal or a barium fluoride crystal.

16. The illumination system as claimed in claim 9, wherein the polarization-rotating device comprises an element made from an optically active material, and a thickness of the element is dimensioned in the transradiation direction such that a prescribed rotation of a preferred polarization direction is effected.

17. The illumination system as claimed in claim 16, wherein the element consists of an optically active material made from crystalline quartz.

18. The illumination system as claimed in claim 17, wherein the crystalline quartz is silicon dioxide.

19. The illumination system as claimed in claim 9, wherein the polarization-rotating device comprises a retardation element, with the effect of a λ/2 plate, that consists of a transparent material with stress birefringence that is stressed with the aid of externally acting mechanical forces such that the retardation element has the λ/2 retardation effect.

20. The illumination system as claimed in claim 19, wherein the retardation element is a plate made from amorphous quartz glass or from calcium fluoride.

21. The illumination system as claimed in claim 1, wherein the second deflecting mirror is aligned perpendicular to the first deflecting mirror.

22. The illumination system as claimed in claim 1, that is designed for ultraviolet light with an operating wavelength of less than 260 nm.

23. Microlithography projection exposure apparatus having an illumination system for illuminating a mask with the aid of the light of a primary light source, and having a projection objective for imaging a pattern of the mask onto a substrate to be exposed, wherein the illumination system is designed in accordance with claim 1.

24. The projection exposure apparatus as claimed in claim 23, wherein the projection objective is an immersion objective.

25. The projection exposure apparatus as claimed in claim 24, wherein during immersion operation, the projection objective has an image-side numerical aperture NA>1.
